(19) United States
(12) Patent Application Publication
(10) Pub. No.: US 2018/0011190 A1
(43) Pub. Date: Jan. 11, 2018

(54) High Ping Rate Sonar

(71) Applicant: NAVICO HOLDING AS, Egersund (NO)

(72) Inventors: Hector Morales, Ensenada (MX); Cristian Barrera, Ensenada (MX)

(21) Appl. No.: 15/202,175

(22) Filed: Jul. 5, 2016

(51) Int. Cl. G01S 15/08; G01S 15/89; G01S 7/56; G01S 15/96; G01S 7/536

(52) U.S. Cl. CPC G01S 15/08; G01S 15/96; G01S 7/536; G01S 7/56; G01S 15/8902

(57) ABSTRACT

An apparatus, method, and computer-readable medium for high ping rate depth sounding. The apparatus may cause transmission of a first sonar beam having a first frequency and transmission of a second sonar beam having a second frequency with a transducer assembly. The transducer assembly maybe configured to transmit the first sonar beam and the second sonar beam into the underwater environment. The apparatus may receive sonar return data from the transducer assembly beginning either simultaneously with transmission of the first sonar beam or prior to transmission of the second sonar beam. The apparatus may further determine, based on sonar return data acquired after transmission of both the first sonar beam and the second sonar beam, that the sonar return data corresponds to the first sonar beam by determining that the sonar return data comprises the first frequency.

### FIELD OF THE INVENTION

Embodiments of the present invention relate generally to sonar systems and, more particularly, to sonar systems, assemblies, and associated methods for high ping rate sonar sounding.

### BACKGROUND OF THE INVENTION

Sonar (SOund Navigation And Ranging) has long been used to detect waterborne or underwater objects. For example, sonar devices may be used to determine depth and bottom topography, detect fish, locate wreckage, etc. Sonar beams from a transducer assembly can be transmitted into the underwater environment. The sonar signals reflect off objects in the underwater environment (e.g., fish, structure, sea floor bottom, etc.) and return to the transducer assembly, which converts the sonar returns into sonar data that can be used to produce an image of the underwater environment.

In some instances, the rate at which successive sonar beams are transmitted (“ping rate”) by these sonar devices is limited by the travel speed of the sonar beams in the underwater environment. In particular, traditional sonar must wait for a transmitted sonar beam to return to the device before sending a subsequent beam to avoid interference between the beams. This may result in slow refresh rates for a marine electronic device and poor resolution of the underwater environment. This problem may be particularly noticeable in deep-water sounding, where travel times are substantially greater. Applicant has developed methods and systems detailed herein to improve the sonar process and the resulting sonar images.

### BRIEF SUMMARY OF THE INVENTION

Example embodiments of the present invention provide apparatuses, methods, and computer-readable medium for high ping rate depth sounding. In an example embodiment, an apparatus comprises a processor and a memory including computer program code. The memory and the computer program code configured to, with the processor, cause the apparatus to cause transmission of a first sonar beam having a first frequency from a transducer assembly at a first time, wherein the transducer assembly is configured to transmit the first sonar beam into an underwater environment. The memory and the computer program code are further configured to, with the processor, cause the apparatus to cause transmission of a second sonar beam having a second frequency from the transducer assembly at a second time, wherein the transducer assembly is configured to transmit the second sonar beam into the underwater environment, and wherein the first time is prior to the second time. The memory and the computer program code are further configured to, with the processor, cause the apparatus to receive sonar return data from the transducer assembly beginning either simultaneously with transmission of the first sonar beam at the first time or prior to transmission of the second sonar beam at the second time, wherein the sonar return data is formed from sonar returns received by the transducer assembly and converted into the sonar return data. The memory and the computer program code are further configured to, with the processor, cause the apparatus to determine, based on sonar return data acquired after transmission of both the first sonar beam and the second sonar beam, that at least a portion of the sonar return data corresponds to the first sonar beam by determining that the sonar return data comprises the first frequency.

In some embodiments, the memory and the computer program code are further configured to, with the processor, cause the apparatus to determine that the sonar return data comprises the first frequency by filtering the sonar return data to detect the first frequency. In some embodiments, the first frequency is orthogonal to the second frequency. The memory and the computer program code may be further configured to, with the processor, cause the apparatus to filter the sonar return data to generate filtered sonar return data by removing a portion of the sonar return data corresponding to the second frequency. Additionally, the memory and the computer program code may be further configured to, with the processor, cause the apparatus to generate an image using the filtered sonar return data and cause display of the image on a display device.

In some embodiments, the memory and the computer program code are further configured to, with the processor, cause the apparatus to determine that the sonar return data further corresponds to the second sonar beam, such that the sonar return data corresponds to both the first sonar beam and the second sonar beam. The memory and the computer program code may be further configured to, with the processor, cause the apparatus to determine that the sonar return data corresponds to the first sonar beam and the second sonar beam by filtering the sonar return data to detect each of the first frequency and the second frequency.

In some embodiments, the memory and the computer program code are further configured to, with the processor, cause the apparatus to cause transmission of a third sonar beam having a third frequency from the transducer assembly at a third time, wherein the transducer assembly is configured to transmit the third sonar beam into the underwater environment, wherein the third time is after both the first time and the second time. The memory and the computer program code may be further configured to, with the processor, cause the apparatus to determine, based on sonar return data acquired after transmission of the first sonar beam, the second sonar beam, and the third sonar beam, that at least a portion of the sonar return data corresponds to the third sonar beam by determining that the sonar return data comprises the third frequency. Additionally, the memory and the computer program code may be further configured to, with the processor, cause the apparatus to determine that the at least a portion of the sonar return data corresponds to the third sonar beam by filtering the sonar return data to remove sonar return data corresponding to at least two frequencies that are orthogonal to the third frequency, wherein the at least two frequencies that are orthogonal to the third frequency include the first frequency and the second frequency.

In some embodiments, the memory and the computer program code are further configured to, with the processor, cause the apparatus to determine a depth of the underwater environment, and wherein the apparatus is configured to cause transmission of the second sonar beam when the underwater environment is deeper than a predetermined depth.

In some embodiments, the memory and the computer program code are further configured to, with the processor, cause the apparatus to cause transmission of a third sonar beam at a third frequency after transmission of both the first sonar beam and the second sonar beam, wherein a first time interval between the transmission of the first sonar beam and the second sonar beam is different than a second time interval between transmission of the second sonar beam and the third sonar beam.

In some embodiments, the memory and the computer program code are further configured to, with the processor, cause the apparatus to apply an echo cancellation technique to sonar return data acquired during transmission of sonar beams, wherein the echo cancellation technique cancels at least a portion of the sonar return data corresponding to a frequency used for the transmission so as to cancel interference from the transmission of the sonar beam.

In another example embodiment, a method for high ping rate depth sounding is provided. The method comprises causing transmission of a first sonar beam having a first frequency from a transducer assembly at a first time, wherein the transducer assembly is configured to transmit the first sonar beam into an underwater environment. The method may also include causing transmission of a second sonar beam having a second frequency from the transducer assembly at a second time, wherein the transducer assembly is configured to transmit the second sonar beam into the underwater environment, and wherein the first time is prior to the second time. The method may also include receiving sonar return data from the transducer assembly beginning either simultaneously with transmission of the first sonar beam at the first time or prior to transmission of the second sonar beam at the second time, wherein the sonar return data is formed from sonar returns received by the transducer assembly and converted into the sonar return data. The method may further include determining, based on sonar return data acquired after transmission of both the first sonar beam and the second sonar beam, that at least a portion of the sonar return data corresponds to the first sonar beam by determining that the sonar return data comprises the first frequency. Example methods of the present invention may also include additional embodiments as described herein, such as described above with respect to the example apparatus.

In yet another example embodiment, a non-transitory computer-readable medium is provided. The non-transitory computer-readable medium comprises at least one memory device having computer program instructions stored thereon, the computer program instructions being configured, when run by a processor, to cause transmission of a first sonar beam having a first frequency from a transducer assembly at a first time, wherein the transducer assembly is configured to transmit the first sonar beam into an underwater environment. The computer program instructions may be further configured, when run by a processor, to cause transmission of a second sonar beam having a second frequency from the transducer assembly at a second time, wherein the transducer assembly is configured to transmit the second sonar beam into the underwater environment, and wherein the first time is prior to the second time. The computer program instructions may be further configured, when run by a processor, to receive sonar return data from the transducer assembly beginning either simultaneously with transmission of the first sonar beam at the first time or prior to transmission of the second sonar beam at the second time, wherein the sonar return data is formed from sonar returns received by the transducer assembly and converted into the sonar return data. The computer program instructions may be further configured, when run by a processor, to determine, based on sonar return data acquired after transmission of both the first sonar beam and the second sonar beam, that at least a portion of the sonar return data corresponds to the first sonar beam by determining that the sonar return data comprises the first frequency. Example computer-readable medium of the present invention may also include additional embodiments as described herein, such as described above with respect to the example apparatus.

### BRIEF DESCRIPTION OF THE DRAWINGS

Having thus described the invention in general terms, reference will now be made to the accompanying drawings, which are not necessarily drawn to scale, and wherein:

FIG. 1 illustrates a watercraft emitting sonar beams, in accordance with some embodiments discussed herein;

FIG. 2 shows a plot of signal strength versus time for a traditional sonar;

FIG. 3 illustrates a simplified plot of a transducer sounding with time-division and frequency-division multiplexed sonar beams, in accordance with some embodiments discussed herein;

FIG. 4 shows a plot of signal strength versus time for a sonar, in accordance with some embodiments discussed herein;

FIG. 5 shows a block diagram illustrating an example sonar system, in accordance with some embodiments discussed herein;

FIG. 6 shows a marine electronic device, in accordance with some embodiments discussed herein;

FIG. 7 illustrates a flowchart of an example method of high ping rate sounding, in accordance with some embodiments discussed herein; and

FIG. 8 illustrates a flowchart of another example method of high ping rate sounding, in accordance with some embodiments discussed herein.

### DETAILED DESCRIPTION

Exemplary embodiments of the present invention now will be described more fully hereinafter with reference to the accompanying drawings, in which some, but not all embodiments of the invention are shown. Indeed, the invention may be embodied in many different forms and should not be construed as limited to the exemplary embodiments set forth herein; rather, these embodiments are provided so that this disclosure will satisfy applicable legal requirements. Like reference numerals refer to like elements throughout.

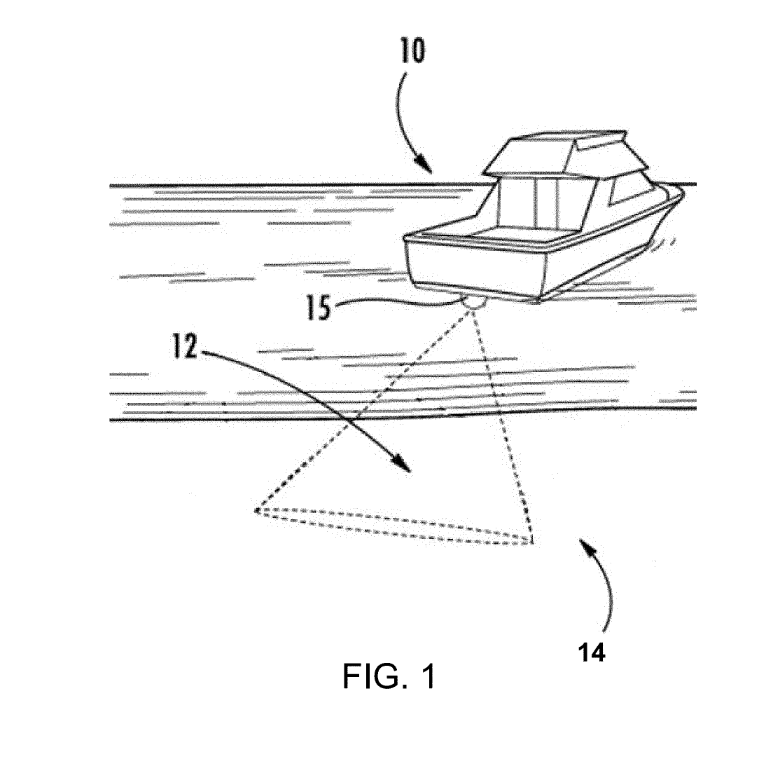

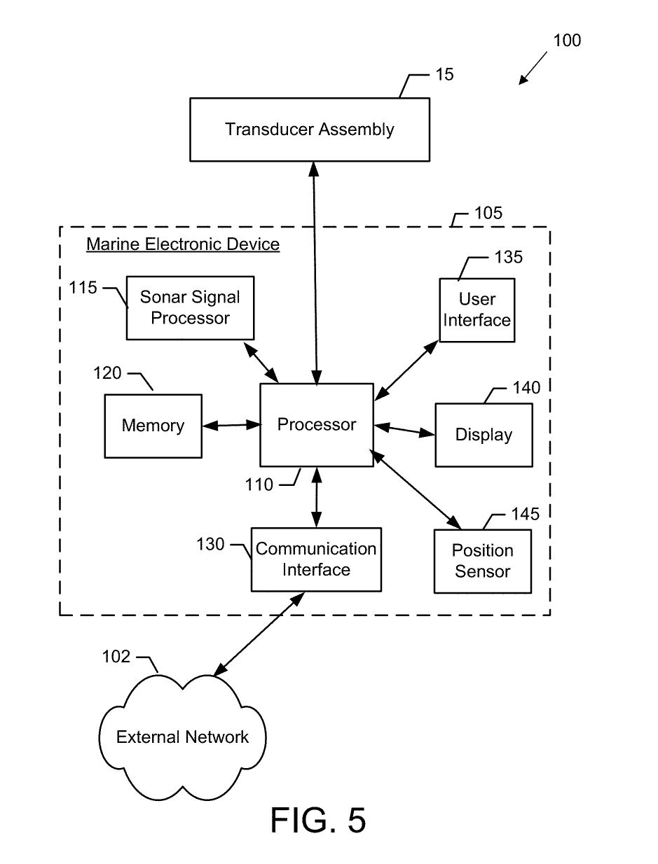

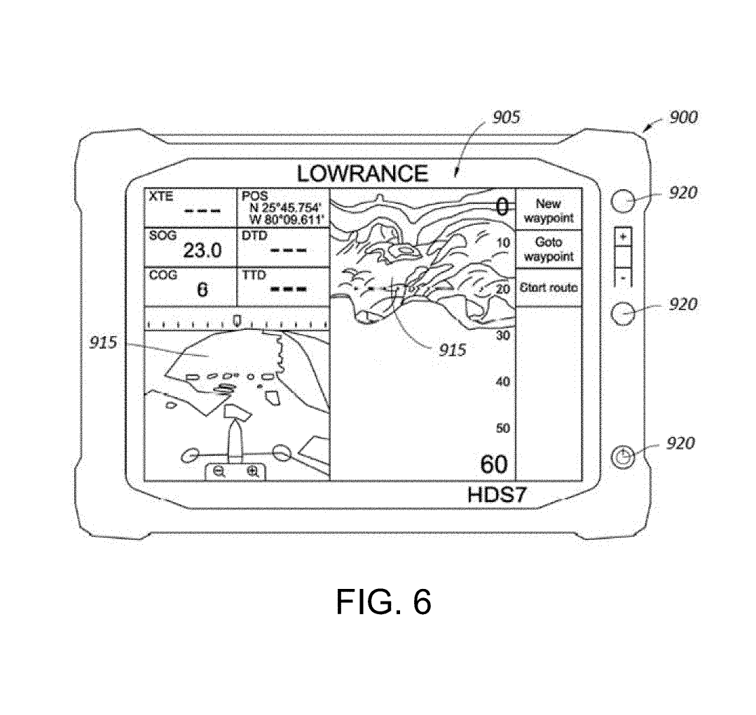

Sonar systems (e.g., sonar system 100 in FIG. 5) are commonly employed by boaters, sport fishermen, search and rescue personnel, researchers, surveyors, and others. With reference to FIG. 1, a watercraft 10 may include a sonar system that includes a transducer assembly 15. The transducer assembly 15 can be attached to the watercraft 10 and configured to transmit one or more sonar beams 12 (shown based on theoretical −3 dB range) into the underwater environment. Sonar signals from the one or more sonar beams can reflect off objects (such as the floor 14 of the body of water, fish, or underwater structures) and return (as sonar returns) to the transducer assembly 15. The transducer assembly 15 (such as through one or more transducers) is configured to convert the sonar returns into electrical energy to form sonar data. This sonar data is received by one or more marine electronic devices (e.g., marine electronic device 105, 900 in FIGS. 5-6) and used to generate an image of the underwater environment (e.g., a sonar image) that can be presented on a display (e.g., display 140 in FIG. 5 or screen 905 in FIG. 6).

Though the example illustrated transducer assembly 15 is attached so as to transmit the sonar beams 12 generally downwardly from the watercraft, other orientations/directions of the transducer assembly 15 are contemplated (e.g., forward facing, rearward facing, downward facing only, side facing only, among others without limitation). Likewise, while the example illustrated transducer assembly 15 is shown with a single sonar beam having a fan-shape corresponding to a linear transducer, other sonar beam shapes (e.g., conical, elliptical, etc.), transducer shapes (circular, square, etc.), and any number of transducers are contemplated by embodiments of the present invention without limitation. In some embodiments, the transducer assembly 15 (shown in FIGS. 1, 3, 5) may include a broadband transducer.

Embodiments of the present invention provide a sonar system (e.g., sonar system 100 of FIG. 5) and associated methods for transmitting and receiving sonar beams with a high ping rate to improve the resolution and refresh rate of the sonar system. In some embodiments, the sonar system 100 is configured to receive sonar data, such as from the transducer assembly (e.g., transducer assembly 15 shown in FIGS. 1, 3, 5), associated with an underwater environment relative to the watercraft. As detailed herein, using the sonar data, the sonar system 100 is configured to form a sonar image that can be displayed to a user on a display (e.g., display 140 or screen 905).

In traditional sonar, the sonar system may be unable to distinguish returns from different pulses, which requires the system to transmit one sonar beam at a time and wait for each set of returns. In addition, overlapping sonar beams may cause interference that impairs the sonar system's ability to receive and process the sonar data.

Because the speed of sound in water is calculable and generally constant at a given location and in a given body of water, the time required for transmitted sonar beams to return to the transducer is directly related to the distance between the transducer and the objects, floor, or other reflective surface from which the sonar beams echo. In embodiments of downwardly-scanning sonar (e.g., “downscan sonar”), the depth of the underwater environment may therefore limit the ping rate of traditional sonar systems to the minimum travel time of a single sonar beam. For example, assuming the speed of sound in water is 1,500 meter per second (4921.26 feet per second), a traditional downscan sonar must transmit at a maximum ping rate of 1 Hz in a 750 meter deep (2,460.63 foot deep) body of water.

This ping rate limitation, in turn, may affect the refresh rate of the sonar system, causing the displayed sonar and depth information to update slowly (i.e., no greater than 1 Hz in the above example). The slow ping rate may also cause the sonar system to have low resolution when the watercraft is moving because the sonar beams may either miss or be unable to distinguish a significant portion of the underwater environment when only using a one ping at a time. As such, traditional sonar systems especially struggle in deep water.

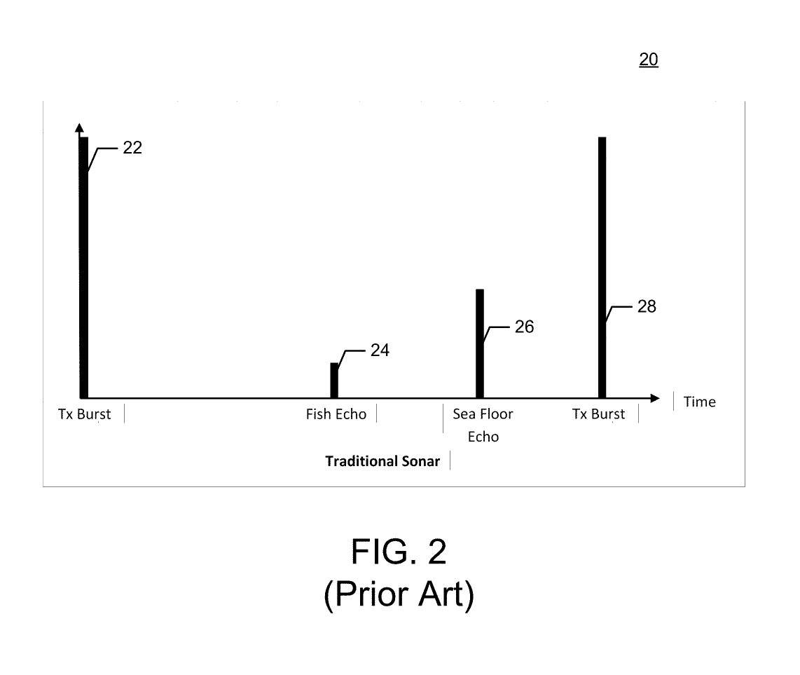

With reference to FIG. 2, a plot 20 of signal strength versus time for a traditional sonar is shown. At an initial time, the sonar may transmit a sonar beam 22 into the underwater environment. At a first, later time, the transducer may receive a first sonar return 24 from a fish or other object in the underwater environment that is above the sea floor. At a second time, after the first time, the sonar may receive a second return 26 from the sea floor. Finally, after the returns 24, 26 have been received, the sonar may transmit a new sonar beam 28 into the underwater environment.

In some embodiments discussed herein, the sonar system 100 (shown in FIG. 5) may transmit and receive sonar beams with a higher ping rate than is possible with traditional sonar systems. Higher ping rates may be achieved by transmitting frequency-division multiplexed sonar beams using one or more transducer assemblies 15 to allow a plurality of sonar beams to travel in the underwater environment simultaneously. In some embodiments, the sonar system 100 may transmit a sequence of multiple orthogonal sonar beams (e.g., orthogonal frequency-division multiplexing) at different times (e.g., time-division multiplexing), with the time difference between beams in the sequence being less than a total travel time for the first-transmitted beam. The sonar system 100 may detect distinct sonar returns from each of the transmitted beams by processing and filtering the received sonar data based on the orthogonality of the sonar returns.

Embodiments of the sonar system 100 may use any number of orthogonal frequencies to produce a sequence of frequency-division multiplexed sonar beams. Orthogonal frequencies may eliminate crosstalk between the different sonar beams, and may allow the sonar system to filter each of the sonar returns from the different beams. Generally, orthogonal signals differ in frequency by an integer multiple of the inverse of the useful symbol period, meaning any integer multiple of the inverse of a transmitted frequency's pulse duration at which the transducer transmits and receives the sonar signals. These pulses, in the form of sonar beams, may be generated and received by the sonar system, for example, using a Fast Fourier Transform (FFT).

With reference to FIG. 5, using the orthogonality of the beams or other frequency-division multiplexing, the processor 110 and/or sonar signal processor 115 may digitally process the sonar returns to filter between different frequencies in the sonar returns and associate the sonar returns with their respective sonar beams (e.g., removing one or more orthogonal frequencies via a digital filter). As used herein, the term “filtering” may include any method to detect, isolate, identify, and/or discriminate one or more frequencies from received sonar return data. For example, in some embodiments, the sonar return data, which may be formed from the sonar returns by the transducer assembly (e.g., transducer assembly 15 shown in FIGS. 1, 3, 5), may be filtered for one or more target frequencies by digitally filtering all other frequencies from the received sonar returns. In a further example, one or more orthogonal frequencies may be filtered from the sonar return data to discriminate between the different frequencies that may be received during the sounding process. In some embodiments, other methods of digital and/or analog processing may be applied to filter the desired sonar returns from the respective sonar beams. In some embodiments, a digital band-pass filter may be selected so its frequency response nulls correspond to peaks of the adjacent orthogonal frequencies.

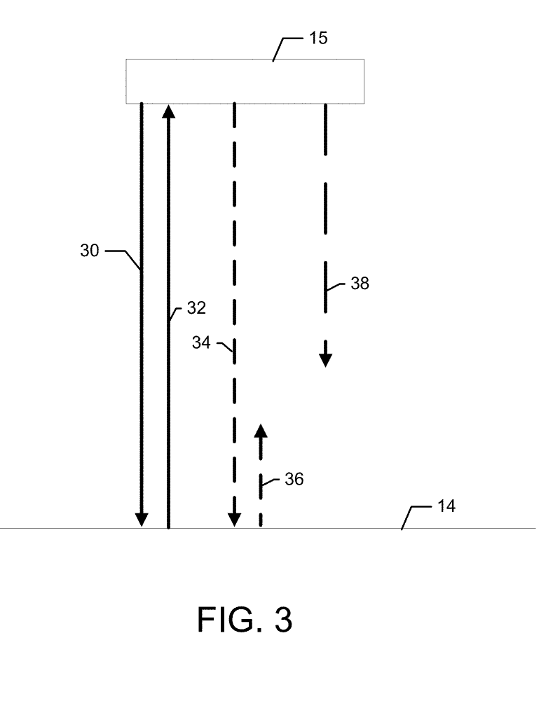

With reference to FIG. 3, an illustration of frequency-division and time-division multiplexed sonar beams 30, 32, 34, 36, 38 is shown. Although the beams 30, 32, 34, 36, 38 are shown separated from one another laterally for illustration purposes, the beams may originate from generally the same position on the watercraft (e.g., an emitting surface of the transducer 15). In the embodiment shown in FIG. 3, a first sonar beam 30, 32 is transmitted from the transducer 15 at a first time and the sonar returns 32 from the beam are received at a later time. Before the first sonar beam 30, 32 returns to the transducer 15, a second beam 34, 36 and a third beam 38 are transmitted at spaced intervals. The first sonar beam 30, 32; second sonar beam 34, 36; and third sonar beam 38 may be transmitted at a first frequency, second frequency, and third frequency respectively. In some embodiments, the first frequency, second frequency, and third frequency may each be different from one another and may each be orthogonal.

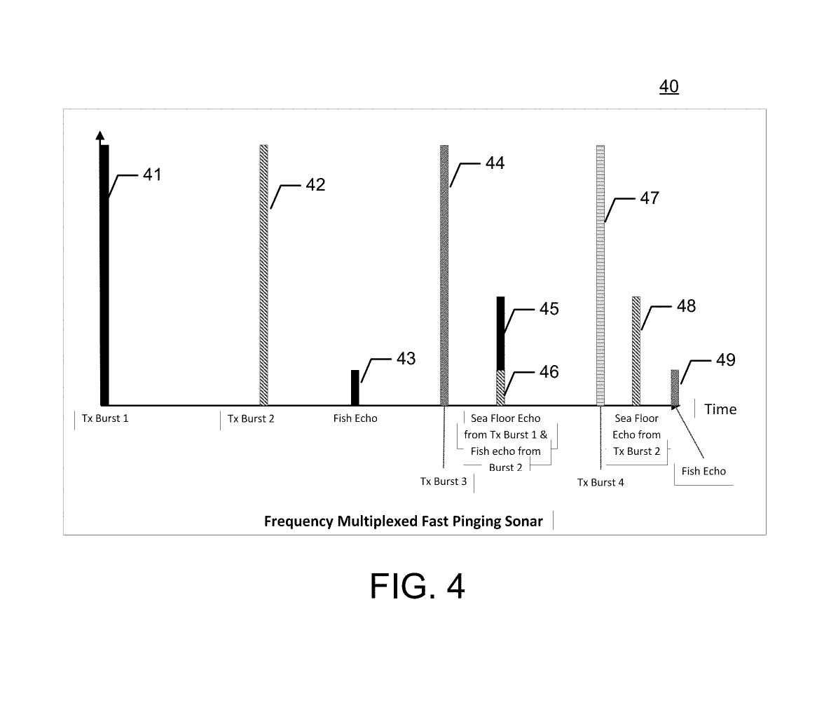

With reference to FIG. 4, another example of frequency-division and time-division multiplexed sonar beams is shown. FIG. 4 depicts a plot of signal strength at the transducer versus time for an example sequence of sonar beams. In the example, at a first initial time, a first sonar beam 41 may be transmitted at a first frequency into the underwater environment. At a second time, a second sonar beam 42 may be transmitted at a second, different frequency into the underwater environment. The sonar system may receive a first sonar return 43 at a third time, and the sonar system may determine that the first sonar return originated from the first sonar beam 41 by identifying the frequency of the sonar returns. In the embodiment of FIG. 4, like frequencies are shown with like patterning on the sonar beam signals. Based upon the signal strength, timing, and the depth of the underwater environment, the sonar system may determine that the first sonar return 43 echoed from a position above the floor (e.g., floor 14 shown in FIGS. 1, 3), such as from a fish or other object in the water.

With continued reference to FIG. 4, at a fourth time, a third sonar beam 44 may be transmitted at a third frequency into the underwater environment. In the example, at a fifth time, two sonar returns 45, 46 may be simultaneously received by the transducer. As discussed herein, the sonar system may digitally filter the received returns to discriminate between a second return 46 from the second sonar beam 42 and an additional first return 45 from the first sonar beam. Based upon the signal strength, timing, and the depth of the underwater environment, the sonar system may determine that the additional first sonar return 45 echoed from the floor (e.g., floor 14 shown in FIGS. 1, 3) while the second sonar return 46 echoed from a fish or other object in the water above the floor. In some embodiments, the display (e.g., display 140 or screen 905) may show the sonar data from each of these identified returns at their detected positions in the body of water.

In the example of FIG. 4, at a sixth time, a fourth sonar beam 47 may be transmitted at a fourth frequency into the underwater environment. At a seventh time, an additional second sonar return 48 may be received and identified as originating from the second sonar beam 42, and the additional second sonar return 48 may be identified as having echoed from the sea floor using the processing and/or filtering techniques described herein. At an eighth time, a third sonar return 49 may be received, associated with the third sonar beam 44 and identified as a fish echo by the processor (e.g., processor 110 and/or sonar signal processor 115 shown in FIG. 5). In some embodiments, as discussed herein, the first frequency, second frequency, third frequency, and fourth frequency may each be different and orthogonal to each other to avoid interference and help the sonar system 100 to distinguish the different returns from each beam as shown above.

The number of different frequencies used in a sequence of sonar beams may depend upon the depth of the water and desired ping rate of the sonar system. In some embodiments, two beams having the same frequency may not travel in the underwater environment at the same time, meaning a first ping at a first frequency should have sufficient time to return to the transducer from the floor prior to transmitting another ping at the same, first frequency. As such, in some embodiments, the number of orthogonal frequencies may be defined by the following Equation (1):

$$n \geq \frac{2 dr}{v}$$

In Equation (1), n represents the number of orthogonal frequencies; d represents the maximum distance that the sonar signal will travel to a target (e.g., the sea floor in downscan embodiments); r represents the desired ping rate, which may be determined by technical limitations of the transducer assembly or user preference; and v represents the speed of sound in water. In some embodiments, other methods of frequency-division multiplexing may be used. For example, another example method could be to use frequency hopping spread spectrum (FHSS) where the transmitted signal is modulated using a pseudo random sequence known to both transmitter and receiver.

In some embodiments, the ping rate may be predetermined or preprogrammed into the sonar system and may be generally constant regardless of depth. In such embodiments, the number of orthogonal frequencies travelling in the water simultaneously may depend on the depth of the body of water. For example, at a constant speed of sound in water, transmitting sonar beams with one ping rate in shallow depths may have few or no beams travelling in the water simultaneously; however, deeper depths may have a large number of simultaneous beams, which may each be orthogonal. For example, in the embodiment of FIG. 3, the farther the floor 14 is from the transducer 15 the greater the amount of time each beam 30, 34, 38 takes to echo from the floor, and the greater the number of orthogonal beams used to maintain a constant ping rate.

In some embodiments, the sonar system may reuse a previous frequency once the previous sonar beam having that same frequency has had sufficient time to echo from the floor or other target. In some embodiments, a large number of orthogonal frequencies may be used regardless of the ping rate or depth. For example, the sonar system may use enough different orthogonal frequencies to allow for a predetermined maximum ping rate at a maximum operating depth. In such embodiments, the frequencies may continue to change and may be reused after all frequencies have been transmitted regardless of depth. As shown in FIG. 4, in some embodiments, the transducer (e.g., transducer 15 shown in FIGS. 1, 3, 5) may continue to transmit sonar beams in different frequencies after returns have been received from earlier transmissions, as long as soundings of the same frequency are separated by greater than the travel time of a sonar beam to the floor and back.

Any ping rate may be chosen depending on a desired refresh rate of the sonar system. For example, the sonar system 100 may be configured to ping at 10 Hz and may use frequency-division multiplexing to allow any number of sonar beams to be traveling in the water simultaneously, as discussed above. In some embodiments, the sonar system may transmit sonar beams at two, three, four, five, or greater times the ping rate of traditional sonar.

In some embodiments, the number and value of frequencies used depends of the transducer's center frequency and bandwidth. For instance, for an example transducer that supports high chirp which typically has a bandwidth of 130-210 kHz, one set of frequencies we could use is 139.510 kHz, 153.460 kHz, 167.410 kHz, 181.362 kHz and 195.312 kHz.

Depending on the desired configuration, different ping rates may be used. For example, theoretically, a system could use any ping rate. However, the ping rate depends on the frequencies and hardware limitations of the system. For example, an example system may have a typical ping rate of 1215 ms for 50 kHz frequency at 1000 ft. For such a system, the ping rate could be theoretically reduced to 243 ms if using 5 frequencies.

In some embodiments, the sonar system may add additional sonar beams per cycle (e.g., the time required for one beam to travel between the transducer and the floor and back to the transducer) at predetermined thresholds. For example, in some embodiments, an additional beam may be added to each cycle for every 500 feet of depth. In some embodiments, the sonar system may operate at one ping per cycle, similar to a traditional sonar, until a predetermined threshold depth (e.g., 1000 feet). In some embodiments, the multiplexing features may be configured to be enabled or disabled by a user via one or more user interface options (e.g., menu options).

In some embodiments, the sonar system 100 may include an initial startup mode, in which the sonar system calibrates prior to steady-state operation. During the initial startup mode, the sonar system 100 may send one or more sonar beams to test the depth of the body of water, or other distance to a target, prior to starting the multiplexed soundings.

In some embodiments, the transmission of sonar beams may interfere with the receipt of sonar returns during the time that the transducer 15 is transmitting. This interference may be caused by a relatively large magnitude of the transmitted beam compared to a received return. For example, in the embodiments shown in FIG. 4, the transducer may sometimes be deaf to any incoming sonar returns during the bursts (e.g., transmission) of the first sonar beam 41, second sonar beam 42, third sonar beam 44, and fourth sonar beam 47. In some embodiments having a transducer that both transmits and receives the transmission bursts may cause greater interference.

The interference of the sonar beam transmissions may be mitigated in one or more ways. In some embodiments, the interval between sonar beams may be staggered, so that the deaf period is not at the same time from beam to beam. The sonar system may then interpolate any missing returns using the returns from adjacent beams. In some embodiments, the sonar system may replace range cell data, which defines a given return, received during the transmission of a sonar beam with interpolated range cell data from adjacent sonar data. In some embodiments, a missing return may be replaced by a copy of the previous sonar return data or subsequent sonar return data near the sonar return data received at time of the transmission of a sonar beam. For example, in some embodiments, a first sonar beam may be transmitted, followed by a second sonar beam 100 ms later, and a third sonar beam may be transmitted 105 ms after the second sonar beam. Similarly, a fourth sonar beam may be transmitted 95 ms after the third sonar beam. The difference in time between sonar beams may be determined as a percentage of the delay between sonar beams (“ping space”), such as for example, 5%. In some embodiments, the variations may alternate between two or more ping spaces. In some embodiments, random variations in the ping space may be more appealing to the human eye.

In some embodiments, the sonar system 100 may include an echo canceller to reduce or cancel interference from transmitted sonar beams in received sonar returns. For example, the sonar system (e.g., via the processor 110 and/or sonar signal processor 115 shown in FIG. 5) may take a sample of the transmitted sonar signal, which may include noise, and use this sample to cancel the transmit signal from any simultaneously received sonar return data. In some embodiments, the signal may be cancelled by subtracting the sample of the transmitted sonar signal from the sonar returns received at the same time as the transmission. Additionally or alternatively, some embodiments of the sonar system may use separate transmit and receive elements and/or shielding to reduce interference.

In some embodiments, other types of echo cancellation may be used. For example, the system could apply image processing type digital filters, use the sampled data to adjust the hardware and/or digital filters, or correlate a certain amount of adjacent ping data before displaying.

### Example System Architecture

FIG. 5 shows a block diagram of an example sonar system 100 capable for use with several embodiments of the present invention. As shown, the sonar system 100 may include a number of different modules or components, each of which may comprise any device or means embodied in either hardware, software, or a combination of hardware and software configured to perform one or more corresponding functions. For example, the sonar system 100 may include a transducer assembly 15 and a marine electronic device 105. An example marine electronic device is shown in FIG. 6.

With continued reference to FIG. 5, the sonar system 100 may also include one or more communications modules configured to communicate with one another in any of a number of different manners including, for example, via a network. In this regard, the communications interface 130 may include any of a number of different communication backbones or frameworks including, for example, Ethernet, the NMEA 2000 framework, GPS, cellular, WiFi, or other suitable networks. The network may also support other data sources, including GPS, autopilot, engine data, compass, radar, etc. Numerous other peripheral devices such as one or more wired or wireless multi-function displays (e.g., a marine electronic device 105) may be included in the sonar system 100.

The marine electronic device 105 may include a processor 110, a sonar signal processor 115, a memory 120, a user interface 135, a display 140, one or more sensors (e.g., position sensor 145, orientation sensor (not shown), etc.), and a communication interface 130. Two or more of the components may be integrated into a single module or component (e.g., the display 140 may also be a touchscreen user interface 135).

The processor 110, which may also operate as a sonar signal processor, or which may include or be operatively connected to a sonar signal processor 115, may be any means configured to execute various programmed operations or instructions stored in a memory device such as a device or circuitry operating in accordance with software or otherwise embodied in hardware or a combination of hardware and software (e.g., a processor or microprocessor operating under software control or the processor embodied as an application specific integrated circuit (ASIC) or field programmable gate array (FPGA) specifically configured to perform the operations described herein, or a combination thereof) thereby configuring the device or circuitry to perform the corresponding functions of the processor 110 as described herein. In this regard, the processor 110 may be configured to analyze electrical signals communicated thereto to provide sonar data indicative of the size, location, shape, etc. of objects detected by the sonar system 100. For example, the processor 110 may be configured to receive sonar return data and process the sonar return data to generate sonar image data for display to a user (e.g., on display 140).

In some embodiments, the processor 110 may be further configured to implement signal processing or enhancement features to improve the display characteristics or data or images, collect or process additional data, such as time, temperature, GPS information, waypoint designations, or others, or may filter extraneous data to better analyze the collected data. It may further implement notices and alarms, such as those determined or adjusted by a user, to reflect depth, presence of fish, proximity of other watercraft, etc. In some embodiments, the processor 110 and/or sonar signal processor 115 may include or be connected to an analog/digital converter.

The memory 120 may be configured to store instructions, computer program code, marine data, such as sonar data, chart data, location/position data, and other data associated with the sonar system in a non-transitory computer readable medium for use, such as by the processor.

The communication interface 130 may be configured to enable connection to external systems (e.g., an external network 102). In this manner, the marine electronic device 105 may retrieve stored data from a remote, external server via the external network 102 in addition to or as an alternative to the onboard memory 120.

The position sensor 145 may be configured to determine the current position and/or location of the marine electronic device 105. For example, the position sensor 145 may comprise a GPS or other location detection system.

The display 140 may be configured to display images and may include or otherwise be in communication with a user interface 135 configured to receive an input from a user. The display 140 may be, for example, a conventional LCD (liquid crystal display), a touch screen display, mobile device, or any other suitable display known in the art upon which images may be displayed.

In any of the embodiments, the display 140 may present one or more sets of marine data (or images generated from the one or more sets of data). Such marine data includes chart data, radar data, weather data, location data, position data, orientation data, sonar data, or any other type of information relevant to the watercraft. In some embodiments, the display may be configured to present such marine data simultaneously as one or more layers or in split-screen mode. In some embodiments, a user may select any of the possible combinations of the marine data for display.

In some further embodiments, various sets of data, referred to above, may be superimposed or overlaid onto one another. For example, the sonar image may be applied to (or overlaid onto) a chart (e.g., a map or navigational chart). Additionally or alternatively, depth information, weather information, radar information, or any other sonar system inputs may be applied to one another.

The user interface 135 may include, for example, a keyboard, keypad, function keys, mouse, scrolling device, input/output ports, touch screen, or any other mechanism by which a user may interface with the system.

Although the display 140 of FIG. 5 is shown as being directly connected to the processor 110 and within the marine electronic device 105, the display 140 could alternatively be remote from the processor 110 and/or marine electronic device 105. Likewise, in some embodiments, the sonar signal processor 115, the position sensor 145, and/or user interface 135 could be remote from the marine electronic device 105.

The transducer assembly 15 according to an exemplary embodiment may be provided in one or more housings that provide for flexible mounting options with respect to the watercraft. In this regard, for example, the housing may be mounted onto the hull of the watercraft or onto a device or component that may be attached to the hull (e.g., a trolling motor or other steerable device, or another component that is mountable relative to the hull of the vessel), including a bracket that is adjustable on multiple axes, permitting omnidirectional movement of the housing.

The transducer assembly 15 may include one or more transducers or transducer elements positioned within the housing. In some embodiments, the transducer 15 may include or be connected to a power amplifier that charges a burst of power for each transmitted sonar beam. Each sonar beam may be a burst of sonar signal at a predetermined frequency and having a non-zero duration. Each transducer may be configured as transmit/receive, transmit-only, or receive-only with respect to transmitting one or more sonar beams and receiving sonar returns.

In some embodiments, each of the transducer elements may be positioned within the housing so as to point toward a predetermined area under, to the side, or the front of the watercraft. The shape of a transducer element may largely determine the type of beam that is formed when that transducer element transmits a sonar pulse (e.g., a circular transducer element emits a cone-shaped beam, a linear transducer emits a fan-shaped beam, etc.). Embodiments of the present invention are not limited to any particular shape of transducer. Likewise, transducer elements may comprise different types of materials that cause different sonar pulse properties upon transmission. For example, the type of material may determine the strength of the sonar pulse. Additionally, the type of material may affect the sonar returns received by the transducer element. As such, embodiments of the present invention are not meant to limit the shape or material of the transducer elements. Further, transducers may configured to transmit and/or receive at different frequencies. In this regard, embodiments of the present invention are not meant to be limited to certain frequencies.

Additionally, in some embodiments, the transducer assembly 15 may have a sonar signal processor (e.g., sonar signal processor 115) and/or other components positioned within the housing. For example, one or more transceivers (e.g., transmitter/receiver), transmitters, and/or receivers may be positioned within the housing and configured to cause the one or more transducers to transmit sonar beams and/or receive sonar returns from the one or more transducers. In some embodiments, the sonar signal processor, transceiver, transmitter, and/or receiver may be positioned in a separate housing.

With reference to FIG. 6, an example marine electronic device 900 is shown. The marine electronic device 900 may include a screen 905 and may have one or more buttons 920 and/or a touchscreen for controlling the sonar system. The marine electronic device 900 may display marine electronic data 915 such as sonar data or other features and functions.

### Example Flowcharts and Operations

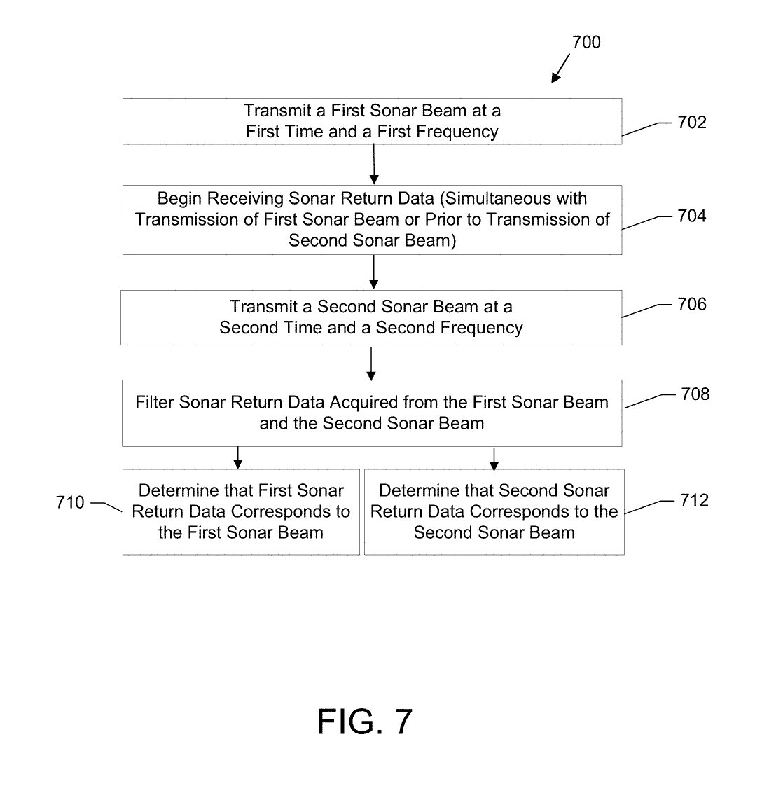

Embodiments of the present invention provide methods, apparatus, and computer readable media for providing high ping rate sonar using frequency-division and/or time-division multiplexing. Various examples of the operations performed in accordance with embodiments of the present invention will now be provided with reference to FIG. 7.

FIG. 7 illustrates a flowchart according to an example method for high ping rate sonar sounding according to an example embodiment 700. The operations illustrated in and described with respect to FIG. 7 may, for example, be performed by, with the assistance of, and/or under the control of one or more of the processor 110, sonar signal processor 115, memory 120, communication interface 130, user interface 135, position sensor 145, display 140, and/or transducer assembly 150, each as shown in FIG. 5.

In the example embodiment, the sonar system (e.g., sonar system 100 shown in FIG. 5) may transmit a first sonar beam at a first time and a first frequency 702. The sonar system may then start receiving sonar return data either simultaneously with transmission of the first sonar beam or prior to transmission of the second sonar beam 704. The sonar system may then transmit a second sonar beam at a second, different time, at a second, different frequency 706. Operations 702, 704, and 706 may be transmitted or received, for example, by the transducer assembly 15, which may be controlled with the assistance of, and/or under the control of one or more of the processor 110, sonar signal processor 115, memory 120, communication interface 130, user interface 135, position sensor 145, and/or display 140, each as shown in FIG. 5.

The sonar system (e.g., sonar system 100 shown in FIG. 5) may filter the sonar return data that was acquired from the first sonar beam and the second sonar beam 708, for example with the transducer assembly 15. Then based on the filtered sonar return data, the sonar system may determine that first sonar return data within the sonar return data corresponds to the first sonar beam 710 and determine that second sonar return data within the sonar return data corresponds to the second sonar beam 712, for example using the transducer assembly and/or the processor 110 and/or sonar signal processor 115.

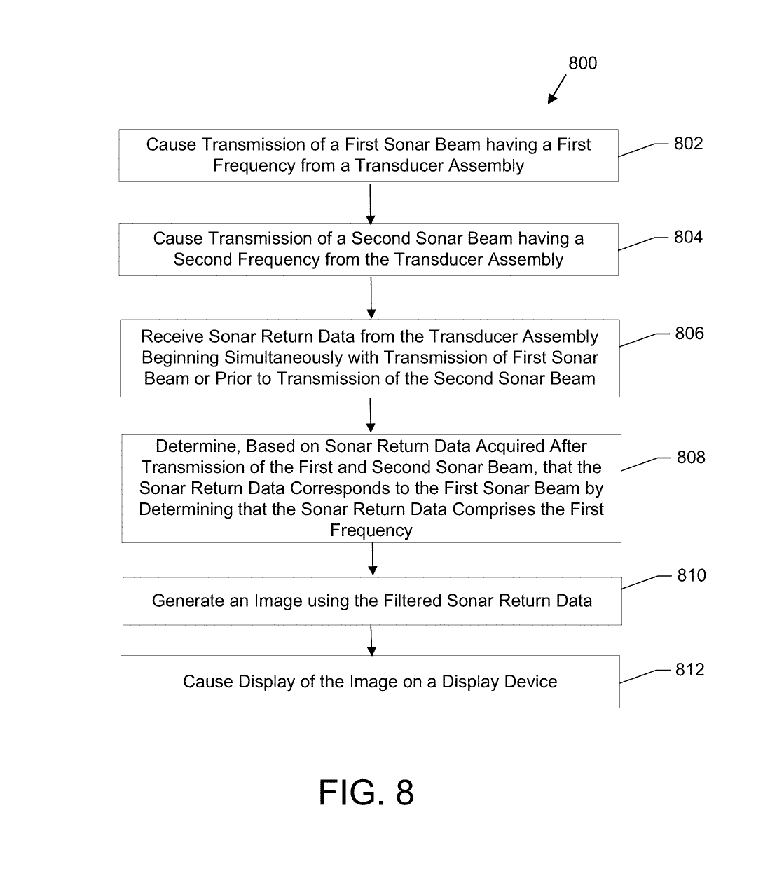

FIG. 8 also illustrates a flowchart according to an example method for high ping rate sonar sounding according to an example embodiment 800 as performed by, for example a processor or sonar signal processor (e.g., processor 110 or sonar signal processor 115 shown in FIG. 5). The operations illustrated in and described with respect to FIG. 7 may, for example, be performed by, with the assistance of, and/or under the control of one or more of the processor 110, sonar signal processor 115, memory 120, communication interface 130, user interface 135, position sensor 145, display 140, and/or transducer assembly 150, each as shown in FIG. 5.

In the example embodiment, the processor or sonar signal processor (e.g., processor 110 or sonar signal processor 115 shown in FIG. 5) may cause transmission of a first sonar beam having a first frequency with a transducer assembly 802. The processor or sonar signal processor (e.g., processor 110 or sonar signal processor 115 shown in FIG. 5) may further cause transmission of a second sonar beam having a second frequency with the transducer assembly 804. The processor or sonar signal processor (e.g., processor 110 or sonar signal processor 115 shown in FIG. 5) may receive sonar return data from the transducer assembly beginning simultaneously with transmission of the first sonar beam or prior to transmission of the second sonar beam 806, and may determine, based on sonar return data acquired after transmission of the first sonar beam and the second sonar beam, that the sonar return data corresponds to the first sonar beam by determining that the sonar return data comprises the first frequency 808. In some embodiments, the apparatus may determine that the sonar return data comprises the first frequency by filtering the sonar return data to detect the first frequency, such as by removing frequencies that do not match the first frequency or other methods detailed herein. In some embodiments, the first frequency may be orthogonal to the second frequency. The apparatus may be configured to filter the sonar return data to generate filtered sonar return data by removing a portion of the sonar return data corresponding to the second frequency.

With continued reference to FIG. 8, in some embodiments, the processor or sonar signal processor (e.g., processor 110 or sonar signal processor 115 shown in FIG. 5) may generate an image for display using the sonar return data 810. In some embodiments, the sonar return data may be the filtered sonar return data corresponding to the returns from one or more of the sonar beams in one or more of the frequencies. In some embodiments, the processor or sonar signal processor (e.g., processor 110 or sonar signal processor 115 shown in FIG. 5) may cause the display of the image on a display device (e.g., display 140 shown in FIG. 5 or screen 905 shown in FIG. 6).

FIGS. 7 and 8 illustrate flowcharts of systems, methods, and computer program products according to example embodiments. It will be understood that each block of the flowcharts, and combinations of blocks in the flowcharts, may be implemented by various means, such as hardware and/or a computer program product comprising one or more computer-readable mediums having computer readable program instructions stored thereon. For example, one or more of the procedures described herein may be embodied by computer program instructions of a computer program product. In this regard, the computer program product(s) which embody the procedures described herein may be stored by, for example, the memory 120 and executed by, for example, the processor 110 or sonar signal processor 115. As will be appreciated, any such computer program product may be loaded onto a computer or other programmable apparatus (for example, a marine electronic device 105) to produce a machine, such that the computer program product including the instructions which execute on the computer or other programmable apparatus creates means for implementing the functions specified in the flowchart block(s). Further, the computer program product may comprise one or more non-transitory computer-readable mediums on which the computer program instructions may be stored such that the one or more computer-readable memories can direct a computer or other programmable device (for example, a marine electronic device 105, 900) to cause a series of operations to be performed on the computer or other programmable apparatus to produce a computer-implemented process such that the instructions which execute on the computer or other programmable apparatus implement the functions specified in the flowchart block(s).

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the embodiments of the invention are not to be limited to the specific embodiments disclosed and that modifications and other embodiments are intended to be included within the scope of the invention. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the invention. In this regard, for example, different combinations of elements and/or functions than those explicitly described above are also contemplated within the scope of the invention. Although specific terms are employed herein, they are used in a generic and descriptive sense only and not for purposes of limitation.

1. An apparatus comprising a processor and a memory including computer program code, the memory and the computer program code configured to, with the processor, cause the apparatus to:
cause transmission of a first sonar beam having a first frequency from a transducer assembly at a first time, wherein the transducer assembly is configured to transmit the first sonar beam into an underwater environment;
cause transmission of a second sonar beam having a second frequency from the transducer assembly at a second time, wherein the transducer assembly is configured to transmit the second sonar beam into the underwater environment, and wherein the first time is prior to the second time;
receive sonar return data from the transducer assembly beginning either simultaneously with transmission of the first sonar beam at the first time or prior to transmission of the second sonar beam at the second time, wherein the sonar return data is formed from sonar returns received by the transducer assembly and converted into the sonar return data; and
determine, based on sonar return data acquired after transmission of both the first sonar beam and the second sonar beam, that at least a portion of the sonar return data corresponds to the first sonar beam by determining that the sonar return data comprises the first frequency.

2. The apparatus of claim 1, wherein the memory and the computer program code are further configured to, with the processor, cause the apparatus to determine that the sonar return data comprises the first frequency by filtering the sonar return data to detect the first frequency.

3. The apparatus of claim 2, wherein the first frequency is orthogonal to the second frequency.

4. The apparatus of claim 3, wherein the memory and the computer program code are further configured to, with the processor, cause the apparatus to filter the sonar return data to generate filtered sonar return data by removing a portion of the sonar return data corresponding to the second frequency.

5. The apparatus of claim 4, wherein the memory and the computer program code are further configured to, with the processor, cause the apparatus to:
generate an image using the filtered sonar return data, and
cause display of the image on a display device.

6. The apparatus of claim 1, wherein the memory and the computer program code are further configured to, with the processor, cause the apparatus to:
determine that the sonar return data further corresponds to the second sonar beam, such that the sonar return data corresponds to both the first sonar beam and the second sonar beam,
wherein the apparatus is configured to determine that the sonar return data corresponds to the first sonar beam and the second sonar beam by filtering the sonar return data to detect each of the first frequency and the second frequency.

7. The apparatus of claim 1, wherein the memory and the computer program code are further configured to, with the processor, cause the apparatus to:
cause transmission of a third sonar beam having a third frequency from the transducer assembly at a third time, wherein the transducer assembly is configured to transmit the third sonar beam into the underwater environment, wherein the third time is after both the first time and the second time; and
determine, based on sonar return data acquired after transmission of the first sonar beam, the second sonar beam, and the third sonar beam, that at least a portion of the sonar return data corresponds to the third sonar beam by determining that the sonar return data comprises the third frequency.

8. The apparatus of claim 7, wherein the memory and the computer program code are further configured to, with the processor, cause the apparatus to determine that the at least a portion of the sonar return data corresponds to the third sonar beam by filtering the sonar return data to remove sonar return data corresponding to at least two frequencies that are orthogonal to the third frequency, wherein the at least two frequencies that are orthogonal to the third frequency include the first frequency and the second frequency.

9. The apparatus of claim 1, wherein the memory and the computer program code are further configured to, with the processor, cause the apparatus to determine a depth of the underwater environment, and wherein the apparatus is configured to cause transmission of the second sonar beam when the underwater environment is deeper than a predetermined depth.

10. The apparatus of claim 1, wherein the memory and the computer program code are further configured to, with the processor, cause the apparatus to:
cause transmission of a third sonar beam at a third frequency after transmission of both the first sonar beam and the second sonar beam,
wherein a first time interval between the transmission of the first sonar beam and the second sonar beam is different than a second time interval between transmission of the second sonar beam and the third sonar beam.

11. The apparatus of claim 1, wherein the memory and the computer program code are further configured to, with the processor, cause the apparatus to:
apply an echo cancellation technique to sonar return data acquired during transmission of sonar beams, wherein the echo cancellation technique cancels at least a portion of the sonar return data corresponding to a frequency used for the transmission so as to cancel interference from the transmission of the sonar beam.

12. A method for high ping rate depth sounding, the method comprising:
causing transmission of a first sonar beam having a first frequency from a transducer assembly at a first time, wherein the transducer assembly is configured to transmit the first sonar beam into an underwater environment;
causing transmission of a second sonar beam having a second frequency from the transducer assembly at a second time, wherein the transducer assembly is configured to transmit the second sonar beam into the underwater environment, and wherein the first time is prior to the second time;
receiving sonar return data from the transducer assembly beginning either simultaneously with transmission of the first sonar beam at the first time or prior to transmission of the second sonar beam at the second time, wherein the sonar return data is formed from sonar returns received by the transducer assembly and converted into the sonar return data; and
determining, based on sonar return data acquired after transmission of both the first sonar beam and the second sonar beam, that at least a portion of the sonar return data corresponds to the first sonar beam by determining that the sonar return data comprises the first frequency.

13. The method of claim 12, wherein determining that the sonar return data comprises the first frequency comprises filtering the sonar return data to detect the first frequency.

14. The method of claim 13, wherein the first frequency is orthogonal to the second frequency.

15. The method of claim 14, wherein filtering the sonar return data to generate filtered sonar return data comprises removing a portion of the sonar return data corresponding to the second frequency.

16. The method of claim 15 further comprising:
generating an image using the filtered sonar return data, and
causing display of the image on a display device.

17. The method of claim 12 further comprising:
causing transmission of a third sonar beam having a third frequency from the transducer assembly at a third time, wherein the transducer assembly is configured to transmit the third sonar beam into the underwater environment, wherein the third time is after both the first time and the second time; and
determining, based on sonar return data acquired after transmission of the first sonar beam, the second sonar beam, and the third sonar beam, that at least a portion of the sonar return data corresponds to the third sonar beam by determining that the sonar return data comprises the third frequency.

18. The method of claim 17, wherein determining that the at least a portion of the sonar return data corresponds to the third sonar beam comprises filtering the sonar return data to remove sonar return data corresponding to at least two frequencies that are orthogonal to the third frequency, wherein the at least two frequencies that are orthogonal to the third frequency include the first frequency and the second frequency.

19. A non-transitory computer-readable medium comprised of at least one memory device having computer program instructions stored thereon, the computer program instructions being configured, when run by a processor, to:
cause transmission of a first sonar beam having a first frequency from a transducer assembly at a first time, wherein the transducer assembly is configured to transmit the first sonar beam into an underwater environment;
cause transmission of a second sonar beam having a second frequency from the transducer assembly at a second time, wherein the transducer assembly is configured to transmit the second sonar beam into the underwater environment, and wherein the first time is prior to the second time;
receive sonar return data from the transducer assembly beginning either simultaneously with transmission of the first sonar beam at the first time or prior to transmission of the second sonar beam at the second time, wherein the sonar return data is formed from sonar returns received by the transducer assembly and converted into the sonar return data; and
determine, based on sonar return data acquired after transmission of both the first sonar beam and the second sonar beam, that at least a portion of the sonar return data corresponds to the first sonar beam by determining that the sonar return data comprises the first frequency.

20. The computer-readable medium of claim 19, wherein the computer program instructions are configured, when run by the processor, to determine that the sonar return data comprises the first frequency by filtering the sonar return data to detect the first frequency, wherein the first frequency is orthogonal to the second frequency.
